(19) United States
(12) Patent Application Publication
(10) Pub. No.: US 2019/0213877 A1
(43) Pub. Date: Jul. 11, 2019

(54) CONTROL SYSTEM AND CONTROL METHOD FOR A MOTOR VEHICLE, COMPRISING A DATABASE

(71) Applicant: Lucas Automotive GmbH, Koblenz (DE)

(72) Inventors: Georg Schneider, Urbar (DE); Thomas Mueller, Bonn (DE); Philipp Mungenast, Montabaur (DE)

(21) Appl. No.: 16/243,137

(22) Filed: Jan. 9, 2019

(30) Foreign Application Priority Data
Jan. 9, 2018 (DE) 102018000101.7

(51) Int. Cl. G08G 1/09; G08G 1/01; H04W 4/46; G08G 1/0962; G08G 1/052; G06F 16/22; G06F 16/25

(52) U.S. Cl. CPC G08G 1/091; G08G 1/0112; H04W 4/46; G06F 16/252; G08G 1/0962; G08G 1/052; G06F 16/22; G08G 1/0125

(57) ABSTRACT

A control system for a motor vehicle is based on environmental sensors of the motor vehicle and on a database. The environmental sensors are arranged and configured to capture an environment of the motor vehicle continuously and to provide environmental data of the motor vehicle. A position sensor is arranged and configured to detect a position of the motor vehicle continuously and to provide position data of the motor vehicle. A speed sensor is arranged and configured to detect a speed of the motor vehicle continuously and to provide speed data of the motor vehicle. A timer is configured to determine respectively current time information. A database is configured to store transmitted data sets and to provide stored data sets. An interface is arranged and configured to transmit traffic information to a driving instance of the motor vehicle. A controller is configured to prepare a data set repeatedly in a predetermined time interval at least using the environmental data, using the position data, using the speed data and using time information and to transmit it to the database. The controller is further configured to determine traffic information repeatedly using the respectively prepared data set and using data sets stored in the database and to effect transmission of the traffic information to the driving instance of the motor vehicle by the interface as a function of the determination.

### BACKGROUND

Disclosed here are a control system for a motor vehicle, with a database, and a corresponding method. This system and the associated method can be used in particular to support the driver in driver-controlled motor vehicles, but can also be used in a motor vehicle with completely or partially autonomous control. Details thereof are defined in the claims; the description and the drawings also contain relevant information about the system and the mode of operation as well as about variants of the system and the method.

### TECHNICAL FIELD

Support for a driver of a motor vehicle by control or driver assistance systems contributes to the ride comfort and the operating safety of (motor) vehicles. Control or driver assistance systems can support the driver in efficient driving of the motor vehicle in road traffic. User-friendliness of a motor vehicle can be increased by this, the driving of a motor vehicle can be made easier and the safety of all road users can be positively influenced.

Known control systems for motor vehicles are based on sensors, which are positioned on the motor vehicle. In this case sensor data is evaluated by a numerical open- or closed-loop control unit and advice is given to the driver of the motor vehicle or, for example in the case of completely autonomous vehicle control, a control command is issued to an actuator of the vehicle.

It is disadvantageous here that only current sensor data or sensor data of the own motor vehicle captured in a certain preceding period of time can be taken into account to determine advice or control commands. Hazardous traffic situations, which occur, for example, repeatedly at certain places and/or at certain times, must thus be identified respectively by current detections of the sensors.

### UNDERLYING PROBLEM

In spite of existing control systems for motor vehicles with environmental sensors, a requirement thus exists for an improved control system and an improved control method for motor vehicles with environmental sensors, which recognise in particular recurring traffic situations at least partially independently of a current detection of the environmental sensors.

### PROPOSED SOLUTION

This object is achieved by a control system according to claim 1 and a control method according to claim 10. Advantageous configurations are defined by the dependent claims.

A control system for a motor vehicle is based on environmental sensors of the motor vehicle and on a database. The environmental sensors are arranged and configured to capture an environment of the motor vehicle continuously and to provide environmental data of the motor vehicle. An environment of the motor vehicle in this case describes a space around the motor vehicle up to a maximum range of the environmental sensors.

A position sensor is arranged and configured to detect a position of the motor vehicle continuously and to provide position data of the motor vehicle. The position sensor can be part of a satellite navigation system, for example, which can likewise be part of the control system.

A speed sensor is arranged and configured to detect a speed of the motor vehicle continuously, for example relative to a road surface, and to provide speed data of the motor vehicle. The speed sensor can be a tachometer common to motor vehicles, for example.

A timer is configured to determine respectively current time information. By analogy with the position sensor, the timer can also be part of a satellite navigation system, for example, which can likewise be part of the control system. Time information can comprise a calendar date and a time. The time information can comprise, for example, a date as well as an hour, minute and second indication.

A database is configured to store transmitted data sets and to provide stored data sets. The database can comprise in this case at least one physical data store and a database logic unit, which is configured to store data sets in a structured manner in the database and/or retrieve them from this. In one variant, the database can store information/data sets about a road network. In particular, information/data sets about permitted maximum speeds of a certain road network, right of way regulations at certain traffic intersections, accident black spots, traffic jams occurring, average traffic speeds or road sections with a particular inclination to slippery road conditions/icing at low temperatures can be stored in the database.

An interface is arranged and configured to transmit traffic information to a driving instance of the motor vehicle.

A controller is configured to prepare repeatedly at a predetermined time interval, for example at a regular time interval of one second or at a regular time interval of 5 seconds, a data set at least with the environmental data, with the position data, with the speed data and with time information and to transmit it to the database. In a further development, the time interval can also be variable and, for example, be dependent on a speed of the motor vehicle. The dependence can be configured here to be linear or incremental. For example, at a current vehicle speed of below one hundred kilometres per hour, a data set can be prepared respectively at a regular time interval of four seconds and at a current vehicle speed of over one hundred kilometres per hour, a data set can be prepared respectively at a regular time interval of two seconds.

The controller is further configured to determine traffic information repeatedly with the respectively prepared data set and with data sets stored in the database and, as a function of the determination, to effect a transmission of the traffic information by the interface to the driving instance of the motor vehicle. The determination of the traffic information can take place, for example, at the same interval as the preparation of the data sets. Traffic information can inform the driving instance of the motor vehicle about an acute hazard situation, for example, and/or instruct or motivate the driving instance of the motor vehicle to a certain control action of the vehicle.

The controller can further be adapted to detect other current vehicle parameters such as, for example, a positive or negative vehicle acceleration, an axle speed, a fuel reserve, an outside temperature, an activation state of a support system, in particular of an anti-blocking system or of an ESP system/vehicle dynamics control, an activation state of a vehicle brake and/or an activation state of a vehicle headlamp arrangement and to use these vehicle parameters for the preparation of the respective data set and/or for the determination of the traffic information. The vehicle parameters can be determined in this case by suitable vehicle parameter sensors and/or by numerical estimation methods.

The driving instance of the motor vehicle can be in particular a driver of the motor vehicle, wherein the interface is a user interface. In another embodiment, the driving instance can be an autonomous motor vehicle controller and the interface can be an electronic data interface with the autonomous motor vehicle controller.

An advantage of the control system according to the invention compared with known control systems, for example, is that not only current environmental data, vehicle parameters or position data are used to determine traffic information, but instead data sets stored in the database are also used. These data sets can comprise, for example, data sets prepared by the controller at an earlier time and/or other data sets, which were not prepared by the controller. If, for example, at a certain position of the motor vehicle on a road, a particularly pronounced speed reduction/vehicle braking in a statistical comparison is detected repeatedly by the controller, then the controller can effect the transmission of traffic information to the driving instance of the motor vehicle by the interface in the case of renewed driving on the road, before the certain position is reached. The driving instance can be encouraged by this to precautionary braking/a precautionary speed reduction. In addition, the controller can determine possible hazard situations by means of the stored data sets, for example on the basis of position-specific warning information stored in the database.

Another advantage is that, for example, a previous error of the driving instance in a certain traffic situation or in the area of a certain position on a road can be detected and suitable traffic information can be transmitted to the driving instance in the event of renewed driving on the road, for example. A renewed error, for example, can be counteracted by this. For example, the database can also contain information about a maximum permitted speed for a motor vehicle on a road. If the controller determines using the stored data sets that a motor vehicle has already exceeded the maximum permitted speed on a certain road several times in the past, for example, and/or that the motor vehicle is once again approaching the maximum permitted speed on this road, then traffic information about the maximum permitted speed can be transmitted preemptively to the driving instance.

Another advantage is that the database can store accident black spots, for example, and in the event of an identified position of the motor vehicle close to such an accident black spot, the controller can increase sensitivity for the detection of traffic information. For example, a determined exceeding of a maximum speed in the case of a determined position close to an accident black spot can trigger the transmission of traffic information even in the event of only a slight exceeding being detected and/or trigger the transmission of additional traffic information, which advises of the stored accident black spot.

Another advantage is that, for example, even time-correlated behaviour of a driving instance in a traffic situation can be determined by the controller, so that traffic information can already be transmitted preemptively to the driving instance of a motor vehicle. If the controller determines repeatedly around midnight, for example, by means of the vehicle parameters traffic information that indicates overtiredness of a driver, traffic information can be transmitted to the driver of a vehicle in advance (e.g. at 23:30) in a current traffic situation as preventive advice. If the controller repeatedly determines a standing situation of the motor vehicle, for example, on a certain route section of a multilane motorway at the same time of day in each case, then the controller can assume regularly occurring traffic congestion (independently of traffic congestion information stored in the database or otherwise available) and effect the transmission of corresponding traffic information to the driving instance of the motor vehicle even before reaching the defined route section, so that a choice of a road can be influenced, for example.

Traffic information can be, for example, hazard information, congestion information, parking opportunity information or other traffic information.

The environmental sensors can comprise a plurality of sensors. In particular, the environmental sensors can comprise one or more optically detecting sensors, in particular one or more camera sensors.

The environmental sensors can further be arranged and configured to detect an environment of the motor vehicle at least substantially without interruption, so that a detection range of the environmental sensors comprises/covers at least an imaginary torus or an imaginary slice of a cylindrical ring, which surrounds the motor vehicle and the radius of which is oriented parallel to a road surface on which the motor vehicle is moving.

In a further development, the environmental sensors can further comprise a rain sensor or the controller can access a rain sensor, for example the rain sensor of a windscreen washer system/windscreen wiper system of the motor vehicle. Precipitation data determined by the rain sensor can be used or taken into account by the controller to prepare the respective data set or in the determination of the traffic information.

The control system can further comprise at least one operating element, which is arranged and configured to detect a control action of the driving instance, in particular of the driver of the motor vehicle, and to transmit control information to the controller as a function of detecting the control action. In this case the controller can further be configured to prepare the data set in addition also with the transmitted control information.

An operating element can be a switch or a lever, for example, for the control of a direction indicator by the driver of a motor vehicle, which switch or lever is arranged and configured so as to, in the event of its actuation, apart from activating a direction indicator, also transmit control information corresponding to this to the controller. In one variant, either all or at least a portion of the operating elements/control elements of the motor vehicle that can be actuated by the driver of a motor vehicle and/or an autonomous motor vehicle controller can be adapted to transmit control information to the controller in the event of actuation by the driver of a motor vehicle and/or an autonomous motor vehicle controller. In particular, a steering wheel, an accelerator pedal, a brake pedal, a clutch pedal, a gear lever and/or a switch for activating a speed assistant/cruise control (or operating elements comparable in their function respectively to these operating elements cited by way of example) can be configured to transmit corresponding control information to the controller in the event of their actuation.

In one variant, the control system can have at least one display element for the driver of the motor vehicle, which is connected electronically to the user interface and is arranged and configured to display the traffic information determined by the controller in an optically recognisable manner for the driver of a motor vehicle. Alternatively or in addition, depending on the traffic information determined, an optical and/or acoustic and/or haptic warning signal can be transmitted to the driver of the motor vehicle, for example by the display element and/or additional warning elements, in particular loudspeakers in the interior of the motor vehicle.

For example, the display element can be an LCD screen in the interior of the motor vehicle, in particular in a dashboard of the motor vehicle, or a display of an on-board computer. Warning lights and/or a heads-up display can also be a display element in the sense of the invention.

A haptic warning signal, for example a vibration of a driver's seat in the motor vehicle, can increase the attentiveness of a driver in a traffic situation. If the controller determines with the data sets, for example, that momentary nodding off or fatigue of the driver is to be suspected, a vibration of the driver's seat can be initiated by a vibration actuator.

The interface can further be adapted to issue a control command to an actuator controller of the motor vehicle and/or, depending on the control command, to transmit an optical warning signal, in particular by the display element, to the driver of the motor vehicle. Furthermore, depending on the control command, an acoustic and/or haptic warning signal can be transmitted to the driver of the motor vehicle, for example by the display element and/or additional warning elements, in particular loudspeakers.

If the controller determines traffic information, for example, which induces an acutely hazardous traffic situation, for example an imminent rear-end collision, which is detected by an optically recording sensor, then the controller can directly initiate an actuation of the vehicle brakes by the interface, in order to mitigate the consequences of a rear-end collision. In addition, an acoustic warning signal can be transmitted to the driver.

An advantage here is that even motor vehicles without autonomous vehicle control can be controlled, in particular braked, by the controller in acutely hazardous traffic situations. For example, imminent collisions of vehicles can be recognised and their effects mitigated, wherein a reaction time of a human driver can be circumvented or cut by the direct activation of actuator controllers by the interface.

In a further development, the database can comprise an evaluation unit, which is configured to read repeatedly stored data sets from the database in a predetermined evaluation time interval, to compare the read data sets and, as a function of the comparison of the read data sets, to add evaluation information, for example hazard information, to the data sets. The evaluation unit can further be configured to store the data sets with the stored evaluation information in the database. In one variant, the data sets to which evaluation information was added can replace/overwrite the respectively corresponding original data sets.

The evaluation time interval can have, for example, the duration of an hour or a day or a week.

An advantage in this case is that the data sets stored in the database can be continuously improved and/or added to, for example by means of the capture of the environmental sensors.

In one embodiment, the database can be implemented outside of the motor vehicle, for example by a stationary database server. The database can be adapted in this case to be connected by a wireless data connection, for example by a mobile phone connection or satellite communications connection, at least at times to the controller of the motor vehicle. Furthermore, the database can be adapted to store transmitted data sets of a plurality of control systems, which are each implemented in one of a plurality of motor vehicles, and/or to provide stored data sets of a plurality of control systems, which are each implemented in one of a plurality of motor vehicles.

An advantage in this case is that the recordings of environmental sensors and/or vehicle parameters of a plurality of motor vehicles can be merged and thus, for example, the evaluation of the database/databases can be improved. In particular, a data basis for statistical evaluation methods of the evaluation unit and/or for a determination of the controller can be improved.

In one variant, a first database can be implemented physically in the motor vehicle and a second database can be implemented physically outside of the motor vehicle. During an operation of the motor vehicle, only the first database can be used for storage and/or for retrieval of data sets by the controller, wherein the first database and the second database are only synchronised with one another in a predetermined synchronisation time interval of, for example, one week. Alternatively, synchronisation of the first and the second database can take place only on certain occasions, for example on fuelling of the motor vehicle or in a vehicle inspection in a workshop. Synchronisation in this case describes an exchange or mutual complementing of the data sets stored respectively in the databases, wherein a connection between the databases can be created in particular by a wireless data transmission method. The second database can be configured to be synchronised respectively with a plurality of databases, which are each physically implemented in a motor vehicle.

The control system can in addition also have at least one first foreign vehicle interface, which is arranged and configured to detect another foreign vehicle interface, which is arranged in another motor vehicle, for example in another motor vehicle with a similar control system, in a predetermined area around the motor vehicle. Furthermore, the at least one first foreign vehicle interface can create a wireless data connection to the foreign vehicle interface of the other motor vehicle, in particular in order to read from the foreign vehicle interface of the other motor vehicle

environmental data, and/or

position data, and/or

speed data, and/or

time information, and/or

control information, and/or

hazard information

and to transmit it to the controller. Alternatively or in addition, the at least one first foreign vehicle interface can be adapted to transmit

environmental data, and/or

position data, and/or

speed data, and/or

time information, and/or

control information, and/or

hazard information

to other foreign vehicle interfaces. The controller can further be configured to determine the traffic information also using data and/or information read from the foreign vehicle interface of the other motor vehicle. In other words, the controller determines the traffic information in this case with the respectively prepared data set and with data sets stored in the database and additionally with the data and/or information read from the foreign vehicle interface of the other motor vehicle.

An advantage in this case, for example, is that a vehicle speed or a positive or negative acceleration of another road user, for example when entering a road or when changing lanes on a multilane carriageway, can be read and the determination of traffic information for the driving instance of the own motor vehicle can be improved accordingly. In particular, specific behaviour of the other road user can be estimated by the controller. Furthermore, the environmental data captured by environmental sensors of the other road user can be taken into account when determining traffic information for the driving instance of the own motor vehicle and the traffic information thus improved. For example, vehicles or objects that were detected by the environmental sensors of the other road user can also be taken into account in the determination of traffic information for the driving instance of the own motor vehicle.

A control method for a motor vehicle based on environmental sensors of the motor vehicle and on a database comprises the steps:

continuous capture of an environment of the motor vehicle and provision of environmental data of the motor vehicle by the environmental sensors;

continuous determination of a position of the motor vehicle and provision of position data of the motor vehicle by a position sensor;

continuous detection of a speed of the motor vehicle and provision of speed data of the motor vehicle by a speed sensor;

determination of respectively current time information by a timer;

repeated preparation, in each case following the expiry of a predetermined time interval, of a data set with

the environmental data, and

the position data, and

the speed data, and

time information

by a controller;

transmission of the determined data set to a database, which is configured to store transmitted data sets and to provide stored data sets;

repeated determination of traffic information with the respectively prepared data set and with data sets stored in the database;

effecting transmission of the determined traffic information to an interface;

transmission of the traffic information to a driving instance of the motor vehicle by the interface as a function of determination of the traffic information by the controller.

### BRIEF DESCRIPTION OF THE DRAWINGS

Further aims, features, advantages and possible applications result from the following description of exemplary embodiments, which are to be understood as non-restrictive, with reference to the related drawings. All features described and/or depicted show by themselves or in any combination the subject matter disclosed here, even independently of their grouping in the claims or their back-references. The dimensions and proportions of the components shown in the figures are not to scale in this case; they may deviate from what is shown here in embodiments to be implemented.

FIG. 1 shows schematically an example of the arrangement of environmental sensors for a motor vehicle.

FIG. 2 shows schematically an example of the structure of a control system with a database for a motor vehicle.

FIG. 3A, 3B show a traffic situation, in which with the aid of a control system an overtaking possibility is determined for a motor vehicle on a multilane carriageway.

FIG. 4A, 4B show a traffic situation, in which with the aid of a control system the reasonableness of a lane change is assessed for a motor vehicle on a multilane carriageway.

FIG. 5A, 5B show a traffic situation, in which with the aid of a control system for a motor vehicle a lane change situation is assessed.

FIG. 6A, 6B show a traffic situation, in which with the aid of a control system a hazard situation at the end of a tailback is assessed.

FIG. 7A, 7B show a traffic situation, in which with the aid of a control system for a motor vehicle the entry onto a multilane road is supported.

FIG. 8A, 8B show a traffic situation, in which with the aid of a control system a hazard situation is determined for a motor vehicle.

FIG. 9A, 9B show a traffic situation, in which with the aid of a control system the location of a parking opportunity is assessed for a motor vehicle.

### DETAILED DESCRIPTION OF THE DRAWINGS

Components and features that are comparable or identical and having the same effect are provided with the same reference sign in the figures. In some cases, reference signs of individual features and components have also been dispensed with for reasons of clarity, wherein these features and components are already provided with reference signs in other figures. The components and features, which are not described afresh in relation to the further figures, are similar in their configuration and function to the corresponding components and features according to the other figures.

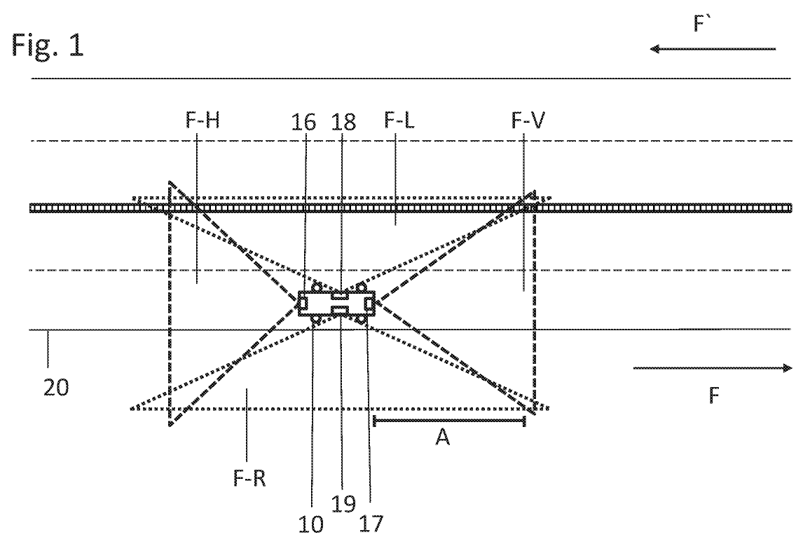

FIG. 1 shows schematically and by way of example a sensor arrangement of four sensors, which together form the environmental sensors of a motor vehicle. The arrangement shown of the sensors and their detection areas are only indicated schematically in FIG. 1 and are intended to make it easier to understand the invention. An environmental sensor system can consist of a single sensor in an extreme case or also comprise up to two hundred individual sensors. The individual sensors can be configured explicitly differently in this case. Thus camera, infrared camera, radar, lidar and/or acoustic sensors, for example, can be connected to one another to give an environmental sensor system.

FIG. 1 shows a motor vehicle 10, which is located on a multilane carriageway 20 of a road and moves in travel direction F. The multilane carriageway 20 shown has four lanes in total, wherein two lanes thereof are provided for movement of vehicles in the travel direction F and two lanes for movement of vehicles in the opposite travel direction F′. The lanes which are provided for movement of vehicles in the travel direction F are separated structurally from the lanes which are provided for movement of vehicles in the opposite travel direction F′.

The motor vehicle 10 shown in FIG. 1 has a rear sensor 16, which has a detection area F-H. The rear sensor 16 is arranged centrally at the rear of the motor vehicle 10, so that an area F-H behind the motor vehicle 10 can be detected. The detection area F-H is not limited in this case by the extension schematically indicated in FIG. 1.

The motor vehicle 10 also has a front sensor 17, which has a detection area F-V. The front sensor 17 is arranged centrally in the vehicle front of the motor vehicle 10, so that an area F-V in front of the motor vehicle 10 can be detected. The detection area F-V is not limited in this case by the extension schematically indicated in FIG. 1.

The motor vehicle shown also has a left lateral sensor 18 and a right lateral sensor 19, which are located on the left (lateral sensor 18) and the right (lateral sensor 19) of the motor vehicle 10 relative to the travel direction shown. The lateral sensors 18, 19 are each positioned centrally on the lateral surfaces of the motor vehicle 10. In one embodiment, lateral sensors can also be positioned, for example, on the wing mirrors of a motor vehicle. The left lateral sensor 18 has a detection area F-L and the right lateral sensor 19 has a right detection area F-R, which each capture an area laterally to the left in the travel direction F and laterally to the right in the travel direction F of the motor vehicle 10.

In the example shown in FIG. 1, the environment of the motor vehicle is captured completely, entirely free of interruption, by the environmental sensors from the surface of the carriageway 20 up to a height of the motor vehicle 10, at least from the predetermined distance A from the motor vehicle 10. The height of the motor vehicle 10 describes its maximum roof height. The capture of the environment here is self-evidently restricted by a range of the sensors, so that a “complete capture” of the environment from the predetermined distance A refers only to a complete capture of the environment in a range of the sensors.

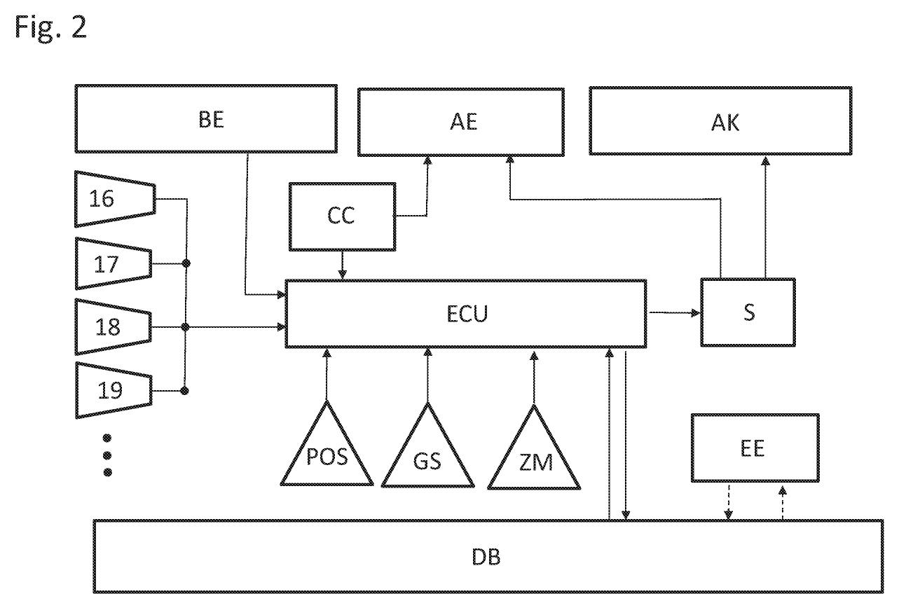

FIG. 2 shows an example of the construction of a control system for a motor vehicle 10. The sensors 16, 17, 18, 19 capture environmental data of the motor vehicle and transmit this environmental data to a controller ECU. The operating elements BE likewise transmit, in the event of their actuation, for example by a driver of the motor vehicle 10, control information to the controller ECU, which indicates the relevant actuation to the controller ECU. In addition, vehicle parameter sensors (not shown) transmit current vehicle parameters to the controller ECU.

A position sensor POS detects a current position of the motor vehicle 10 and transmits this to the controller ECU. The position sensor POS uses a satellite navigation system when doing this.

A speed sensor GS determines continuously a current speed of the motor vehicle 10 and transmits this to the controller ECU.

A timer ZM determines respectively current time information and transmits this to the controller ECU. The timer ZM uses a reference time signal transmitted by a satellite navigation system when doing this.

A foreign vehicle interface or “Car2Car interface” CC checks continuously using an electromagnetically transmitted search signal whether another vehicle with a compatible other foreign vehicle interface (not shown) is located in the own detection area. If the foreign vehicle interface CC detects a compatible other foreign vehicle interface, then the foreign vehicle interface CC automatically initiates a wireless electronic connection set-up. If this is successful, the foreign vehicle interface CC reads environmental data and current vehicle parameters of the other vehicle with the compatible other foreign vehicle interface and transmits these to the controller ECU. A signal is also generated, for example to the driver of the motor vehicle 10, which indicates a successful connection setup to a foreign vehicle. To this end the foreign vehicle interface CC transmits a corresponding signal to a display element AE.

The foreign vehicle interface CC can maintain a wireless electronic connection with a plurality of other vehicles at the same time.

The display element AE is arranged in the interior of the motor vehicle 10 and is configured to reproduce optically recognisable signs for a driver or occupant of the motor vehicle 10. In the example shown, the display element AE comprises a heads-up display and can reproduce/depict information recognisably for a driver or occupant of the motor vehicle both in text form and with the aid of schematic symbols.

The control system shown further has a database DB, which is adapted both to store data sets determined by the controller ECU and to provide previously stored data sets in readable form for the controller ECU. Here the stored data sets can comprise data sets previously determined by the controller ECU or vehicle-independent data sets, for example traffic navigation data sets. The manual input of data sets into the database DB is also explicitly possible.

In the example shown, the controller ECU regularly prepares data sets with the environmental data of the sensors 16, 17, 18, 19 and the captured current vehicle parameters and the control information transmitted by the operating elements BE as well as with the current position, the current speed and time information and transmits these respectively to the database DB for storage.

If a wireless connection set-up of the foreign vehicle interface CC is successful, the data set prepared thus comprises also environmental data and vehicle parameters of at least one other motor vehicle.

Furthermore, the controller ECU regularly determines traffic information with the environmental data of the sensors 16, 17, 18, 19 and the captured current vehicle parameters and the control information transmitted by the operating elements BE as well as with the current position, the current speed and time information, wherein the controller also reads data sets from the database DB for this purpose and also uses them to determine the respective traffic information.

If a wireless connection set-up of the foreign vehicle interface CC is successful, the controller ECU thus further determines the respective traffic information using environmental data and vehicle parameters of at least one other motor vehicle.

Examples of specific traffic information determined by the controller are shown in the further figures and described.

The traffic information determined by the controller ECU is transmitted to the interface S. If the traffic information determined induces an acute hazard situation, the interface S directly transmits a control signal to a vehicle actuator AK. For example, a brake command can be transmitted directly to a brake actuator of the motor vehicle 10, without the driving instance of the motor vehicle 10 confirming/implementing the brake command. Emergency braking can thus be carried out.

If the traffic information determined does not induce an acute hazard situation, only the traffic information and/or a recommended action are transmitted to the driving instance of the motor vehicle. To do this, the interface S in the example shown transmits the traffic information and/or a recommended action to the display element AE, which depicts the traffic information in an optically recognisable manner for a driver or occupant of the motor vehicle 10.

The example of a control system shown in FIG. 2 further comprises an evaluation unit EE, which evaluates once a day the data sets determined by the controller ECU and stored in the database DB. To do this, the evaluation unit EE compares all stored data sets with one another and evaluates these for a correlation with one another. In particular, data sets correlated with one another timewise and/or locally, thus data sets captured respectively at the same location and/or at the same clock time/time of day, for example, are evaluated for statistically conspicuous detections by the sensors and/or statistically conspicuous vehicle parameters. If particularly heavy braking of the motor vehicle at a certain position or at a certain location, for example, is detected repeatedly, then all data sets that were prepared at or in the vicinity of this position/this location can be supplemented with hazard information.

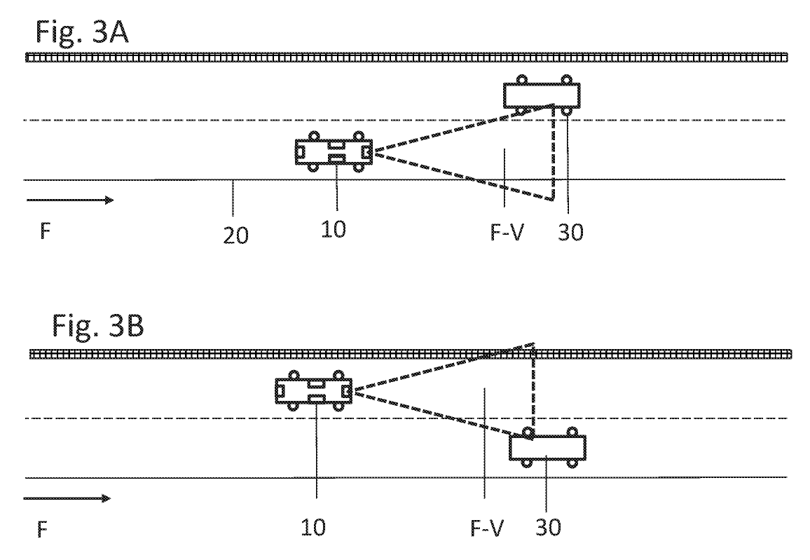

FIGS. 3A and 3B show a traffic situation in which an overtaking opportunity is determined with the aid of a control system for the motor vehicle 10 on a multilane carriageway 20.

The multilane carriageway 20 shown corresponds to the carriageway shown in FIG. 1, wherein in FIGS. 3A and 3B only those lanes are shown that are provided for movement of vehicles in the travel direction F.

The motor vehicle 10 detects with the front sensor 17 (cf. reference sign FIG. 1) a vehicle 30 driving in front on a parallel lane, which vehicle is partly detected by the detection area F-V.

In the example shown, the controller ECU is configured to determine an overtaking opportunity for vehicles driving in front on the carriageway 20. In a further development of the control system, the driver of the motor vehicle 10 can also transmit by the actuation of an operating element BE a targeted query to the controller ECU as to whether an overtaking opportunity exists.

In the example shown in FIG. 3A, the controller ECU determines, using the position determined by the position sensor POS and the navigation information stored in the database, that the motor vehicle 10 is currently located in Germany and on a multilane highway outside of a built-up area.

The controller ECU further determines with the front sensor 17 that the vehicle 30 driving in front is moving in a parallel lane in the travel direction F on the left next to the lane in which the motor vehicle 10 is currently driving, and is moving in the travel direction F. The controller ECU determines using the traffic regulations stored in the database DB and valid for Germany that an overtaking manoeuvre is not permissible and causes the interface S to transmit corresponding traffic information to the display element AE. This displays an existing overtaking ban to a driver or occupant of the motor vehicle 10. If the controller ECU nevertheless determines a closer approach to the vehicle 30 driving in front, the controller ECU additionally initiates the transmission of a warning signal by the interface S. In the example shown, the output of an acoustic warning signal to the occupants of the motor vehicle is initiated.

If the controller ECU were to detect, for example, that the motor vehicle 10 was located, for example, in Germany but—contrary to the previous description—on a multilane road in a built-up area, the controller ECU would transmit traffic information to the interface S that induces a permissibility of the overtaking manoeuvre. The display of a permissible overtaking manoeuvre would accordingly be effected for the driver or occupant of the motor vehicle 10.

Deviating from FIG. 3A, FIG. 3B shows a traffic situation in which the controller ECU determines a permissible overtaking manoeuvre. The controller ECU detects with the front sensor 17 that the vehicle 30 driving in front is located in a parallel lane in the travel direction F on the right next to the lane in which the motor vehicle 10 is currently driving. The controller ECU therefore determines, using the traffic regulations stored in the database DB and valid for Germany, that an overtaking manoeuvre is permissible and causes the interface S to transmit corresponding traffic information to the display element AE.

The database DB can store respectively valid traffic regulations for a plurality of countries/nations/regulation areas and thus, depending on a determined position of the motor vehicle 10, can determine driving behaviour appropriate for the traffic regulations as well as corresponding traffic information for a plurality of countries/nations/regulation areas.

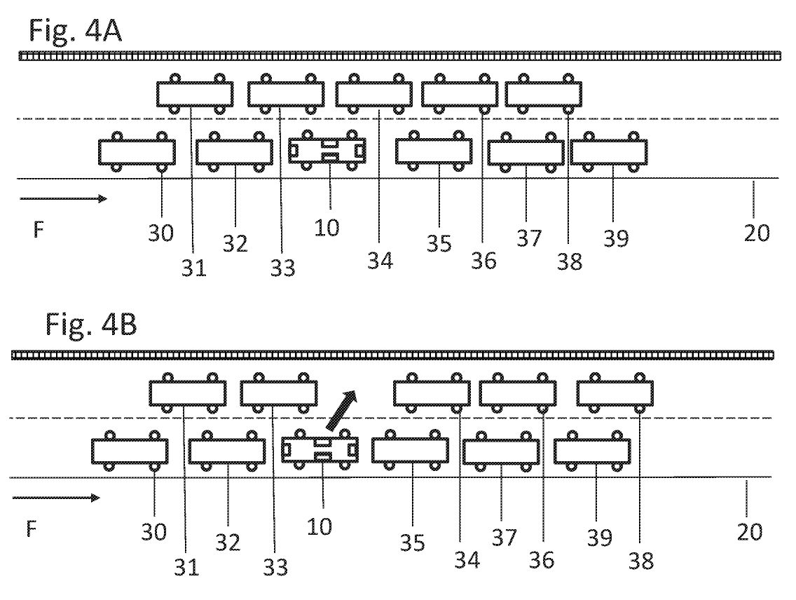

FIGS. 4A and 4B show a traffic situation in which the reasonableness of a lane change for a motor vehicle on a multilane carriageway is determined with the aid of a control system.

FIGS. 4A and 4B show a traffic situation with a heavy traffic flow and vehicles travelling close to one another on a multilane carriageway 20. By analogy with the traffic situation shown in FIGS. 3A and 3B, only those lanes that are provided for movement of vehicles in the travel direction F are shown in FIGS. 4A and 4B.

In the traffic situation shown, the motor vehicle 10 is surrounded by the other vehicles 30 . . . 39, wherein the vehicles 30 . . . 39 shown in the figure are only shown representatively for a plurality of vehicles.

In the example shown, the controller ECU determines, using the current vehicle parameters and the captured environmental data, that the motor vehicle 10 is located in a traffic situation with a heavy traffic flow and vehicles 30 . . . 39 driving close to one another. The controller ECU further determines, using the position determined by the position sensor POS and the navigation information stored in the database, that the motor vehicle 10 is on a multilane carriageway. By means of a plurality of data sets determined in the past by the controller ECU in the area of the current position of the motor vehicle 10, which data sets are stored in the database DB, the controller ECU further determines that the traffic in the left lane in the travel direction F most recently moved relatively faster than the traffic in the right lane in the travel direction F. The controller ECU can be adapted in a further development to verify this ascertainment, which is based on stored data sets, with the aid of the environmental data and the (own) vehicle parameters over a predetermined period, for example over a period of 5 minutes. Furthermore, the ECU can be adapted in a further development to use only those stored data sets that were captured approximately in the same period (of the day) in each case, for example 14:00+/−two hours, for the ascertainment.

If the controller ECU determines that the traffic in another lane of the carriageway 20 is moving faster than in the lane currently travelled in, the controller ECU transmits corresponding traffic information to the interface S. The interface S then effects the transmission of traffic information to the driving instance, which information recommends changing the lane currently travelled in.

In a further development, the controller ECU can be adapted to determine traffic information concerning an optimal lane only at the request of the driving instance.

For example, the driver of a motor vehicle can actuate a corresponding operating element for this.

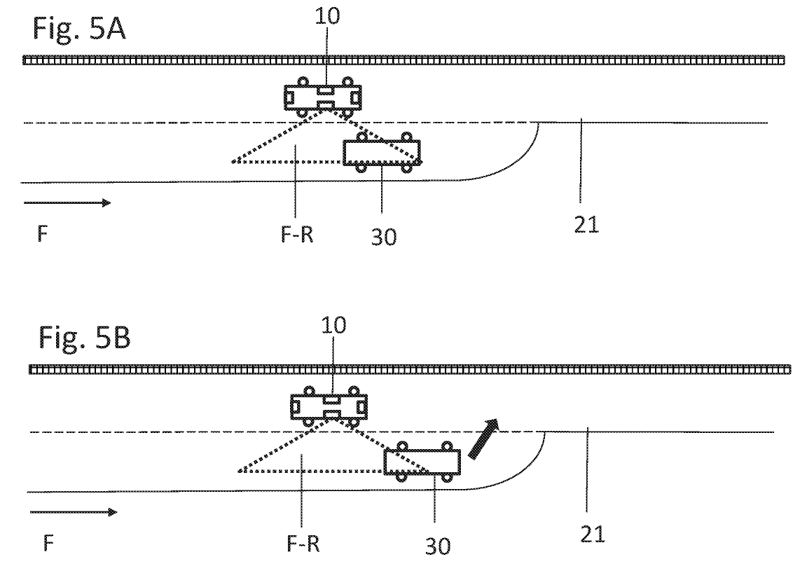

FIGS. 5A and 5B show a traffic situation in which a lane change situation on the entry of another vehicle 30 onto a commonly used carriageway 21 is assessed for a motor vehicle with the aid of a control system.

Deviating from the traffic situations shown in FIGS. 3A to 4B, FIGS. 5A and 5B show a traffic situation with a partially two-lane carriageway 21 that narrows to one lane in the travel direction F.

The own motor vehicle 10 is located in the left lane in the travel direction F and detects with a lateral sensor another vehicle 30 travelling substantially in parallel. Using the position determined by the position sensor POS and the navigation information stored in the database, the controller ECU determines that the motor vehicle 10 is located on a lane that is likely to narrow. The ECU further determines, using the environmental data of the lateral sensor, that a merging of the other vehicle 30 is probably imminent. The controller ECU determines as a function of the detected position of the other vehicle 30 and the own speed whether acceleration or braking of the own motor vehicle 10 is to be recommended to promote road safety. The controller ECU transmits appropriate traffic information to the interface S and causes this to transmit the traffic information to the display element AE. The display element AE thereupon displays a recommended speed to a driver or occupant of the motor vehicle 10.

FIG. 5B shows the traffic situation in FIG. 5A, wherein the driving instance brakes the motor vehicle 10, in order to make it possible for the other vehicle 30 to merge into the self-used lane.

If the controller ECU determines that a driving instance, for example the driver of the motor vehicle, does not follow the speed recommendation, the controller ECU additionally causes the transmission of a warning signal by the interface S. In the example shown, the output of an acoustic warning signal to the occupants of the motor vehicle is initiated.

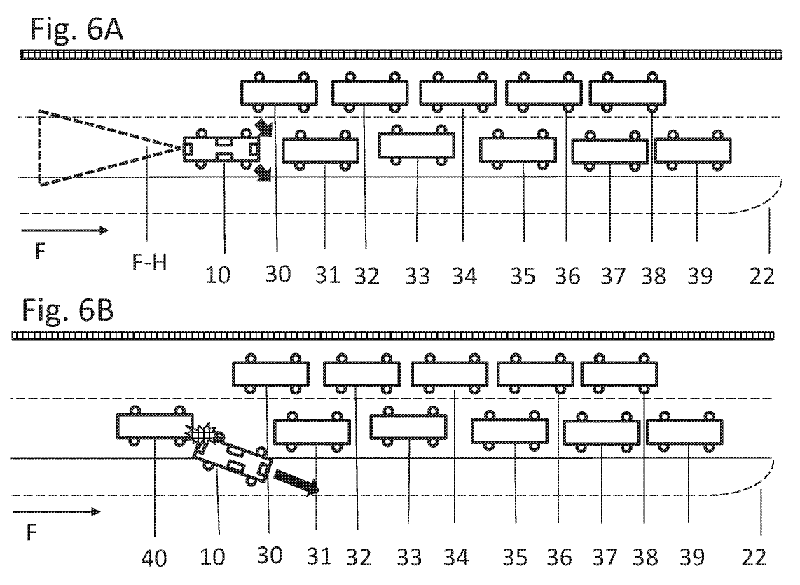

FIGS. 6A and 6B show a traffic situation in which a hazard situation at the end of a tailback is assessed with the aid of a control system.

FIG. 6A shows a traffic situation in which the motor vehicle 10 has joined the end of a tailback and thus forms the last vehicle in a traffic jam of a plurality of other vehicles 30 . . . 39 on a multilane carriageway 22.

By analogy with the previous figures, in the example shown only those lanes of the carriageway that are provided for movement of vehicles in the travel direction F are shown.

The multilane carriageway 22 has a hard shoulder not used by vehicles.

In the example shown, after the motor vehicle 10 has joined the end of a tailback, which is determined, for example, by the environmental sensors and with the vehicle parameters, the controller ECU is adapted to monitor an area behind the own vehicle 10 with the rear sensor 16. If a hazardous vehicle 40 approaches at high speed the own motor vehicle 10 stopped at the end of the tailback, the controller ECU determines an acute hazard situation. If the controller ECU further determines using the environmental sensors and/or the position sensor POS that there is located to the side of the motor vehicle a free space not used by vehicles or other road users, for example a hard shoulder, the controller ECU determines corresponding traffic information, which causes the interface S to actuate—bypassing the driving instance—a steering actuator of the motor vehicle 10 and to pull the steering of the motor vehicle 10 maximally in the direction of the free space. The interface S further causes the production of an acoustic warning signal for the occupants of the motor vehicle 10.

In a further development, the controller ECU can be configured to cause the interface S to take further measures, such as the unilateral actuation of brake actuators of the motor vehicle or the reduction of a trigger threshold for a driver or passenger airbag.

If, as shown in FIG. 6B, a collision of the hazardous vehicle 40 with the motor vehicle 10 occurs, the motor vehicle 10 is pushed by the collision of the hazardous vehicle into the free space, onto the hard shoulder in the example shown, instead of onto the vehicles 30 . . . 39 driving in front. Material damage and personal injury arising due to the collision can be minimised by this.

In a further development, the controller ECU can be further adapted to instruct the interface S in the event of an imminent collision to drive the motor vehicle 10—bypassing the driving instance—autonomously in the direction of the free space detected by the environmental sensors, in order to at least partially avoid a collision.

The controller ECU can further determine using the data sets read from the database DB whether the position of the end of the tailback is a known accident black spot. If it is a known accident black spot, then for the determination of traffic information by the controller ECU that induces an acute collision risk, an approach speed of the hazardous vehicle 40 can be lowered compared with a reference value, which is to be assessed in a normal case as “acutely hazardous”.

It is understood that the emergency measures shown in FIGS. 6A and 6B can be used, for example, also in other stationary situations, for example on a construction site and/or at traffic lights.

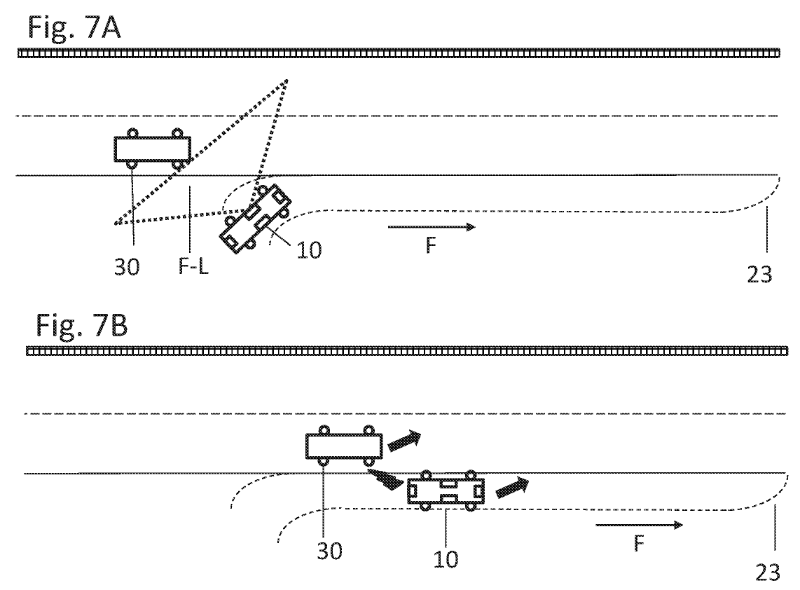

FIGS. 7A and 7B show a traffic situation, in which with the aid of a control system the entry onto a multilane road is supported for a motor vehicle.

The motor vehicle 10 in the traffic situation shown in FIG. 7A is located on a slip road of a multilane carriageway 23. By analogy with the previous figures, in the example shown only those lanes of the carriageway 23 that are provided for movement of vehicles in the travel direction F are shown.

The motor vehicle 10 determines using a lateral sensor that another vehicle 30 is possibly obstructing the entry of the motor vehicle 10 onto the carriageway 23.

As shown in FIG. 7B, using the foreign vehicle interface CC the motor vehicle sets up a wireless data connection with the other vehicle 30, which in the example shown in FIGS. 7A and 7B likewise has a control system with a compatible other foreign vehicle interface. The motor vehicle 10 and the other vehicle 30 exchange respectively captured environmental data and vehicle parameters via the foreign vehicle interface CC and via the other foreign vehicle interface. On the basis of the respectively self-captured environmental data and vehicle parameters and the respectively exchanged environmental data and vehicle parameters, the controller ECU of the motor vehicle 10 determines traffic information that recommends acceleration of the motor vehicle 10, while the other vehicle 30 (or its controller) determines traffic information that recommends a lane change of the other vehicle 30.

The traffic information determined by the controller ECU is transmitted by analogy with the previously described traffic situations to the interface S, which brings about corresponding information/corresponding advice or display to the driving instance of the motor vehicle 10.

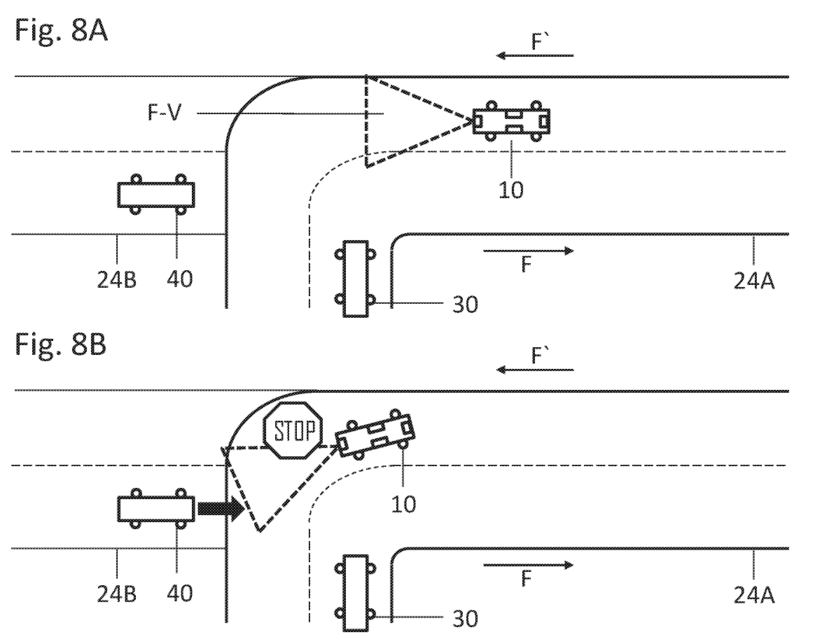

FIGS. 8A and 8B show a traffic situation in which a hazard situation for a motor vehicle is determined with the aid of a control system.

FIGS. 8A and 8B show a road 24A turning off, into which another road 24B opens. The vehicles that are located on the road 24A turning off have right of way at the junction with the road 24B.

In the example shown in FIG. 8A, the motor vehicle 10 approaches the junction with the road 24B in the direction F′.

The controller ECU of the motor vehicle 10 determines by means of a plurality of data sets stored in the database DB, which were already determined at the same place (or geographical position) in the past by the ECU, that the driving instance has already repeatedly braked the motor vehicle 10 sharply at the junction with the road 24B. In addition, the controller ECU of the motor vehicle 10 determines using the data sets stored in the database DB that the junction with the road 24B is an accident black spot.

The controller ECU therefore effects the transmission of a preventive warning signal to the driver or the occupants of the motor vehicle by the interface S. In the example shown, an optically recognisable warning light of the display element AE is activated for this purpose in the interior of the motor vehicle. In addition, a recommendation is transmitted to the driving instance of the motor vehicle 10 to reduce the current speed to maximally 75% of the maximum speed permissible on the basis of statutory regulations.

In addition, the controller ECU shortens by 50% an interval cycle in which traffic information is determined and activates all available sensors, in particular even those sensors that were previously temporarily deactivated on account of detection redundancy and to save energy.

If the controller ECU determines with the environmental sensors, as shown in FIG. 8B, illegal and/or hazardous driving behaviour, for example driving in spite of a right of way impediment, of a hazardous vehicle 40, then the driving instance of the motor vehicle 10 receives corresponding warning information from the interface S. If moreover a predetermined distance between the motor vehicle 10 and the hazardous vehicle 40 has already been undercut, the interface S transmits to the brake actuators of the motor vehicle 10—bypassing the driving instance—a brake command in order to yet prevent an imminent collision or to mitigate its consequences, in particular material damage and personal injury.

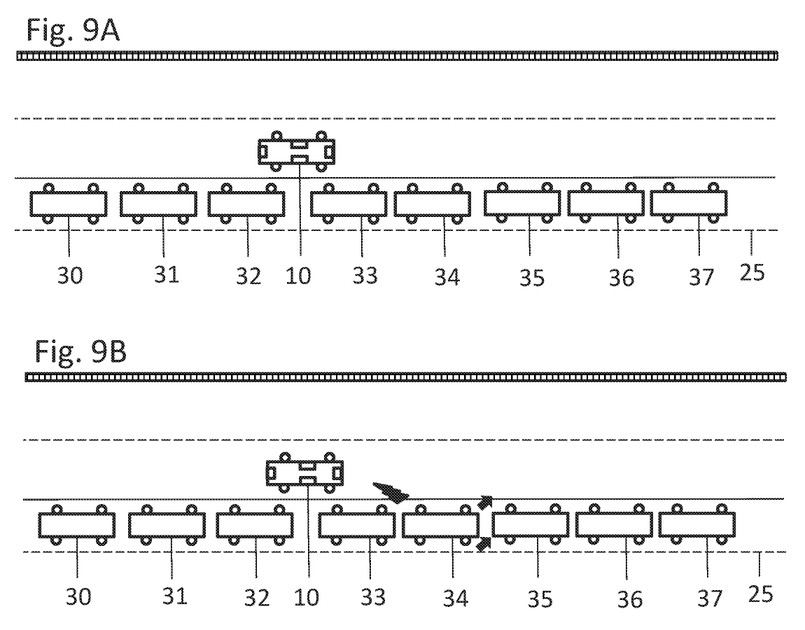

FIGS. 9A and 9B show a traffic situation in which the location of a parking opportunity for a motor vehicle is supported with the aid of a control system.

FIG. 9A shows a motor vehicle 10, the driving instance of which currently intends to stop or park the motor vehicle. The motor vehicle 10 is located in the example shown on a multilane carriageway 25 with a verge that is suitable and released for the parking of motor vehicles. The driving instance of the motor vehicle has transmitted a parking wish to the controller ECU. This can take place, for example, by the actuation of an operating element BE by the driver of the motor vehicle.

The controller ECU of the motor vehicle can be adapted, for example, to determine on the basis of data sets stored in the database DB, which were already determined by the ECU in the past at roughly the same clock time/time of day (e.g. 14:00+/−two hours), an area in the environment of the motor vehicle that at least has a predetermined probability for the occurrence of a suitable parking opportunity at least at a current time.

The controller ECU can further determine on the basis of data sets stored in the database DB and using the position sensor POS a route to a parking opportunity, for example to a car park with free spaces for motor vehicles, wherein the number of free spaces can be determined, for example, by a wireless data connection to a central server, in particular by a mobile phone connection, by the controller ECU and/or by the database DB.

If a parking space that is currently occupied, for example by another vehicle 34, which likewise has a control system as previously described, is vacated, the controller ECU of the motor vehicle can determine this on the basis of transmitted data sets and using the position sensor POS and navigation data stored in the database can determine traffic information, which comprises in particular a route to the parking space that is becoming free.

The transmission of information about the parking space becoming free to the controller ECU of the motor vehicle 10 can, as shown for example in FIG. 9B, be effected via the foreign vehicle interface CC. In this case the controller of the vehicle 34 leaving the parking space is adapted to set up a wireless data connection on start-up of the vehicle 34 with vehicles with a compatible foreign vehicle interface positioned in the vicinity of the vehicle 34 and to indicate departure from the parking space by the transmission of a corresponding data set.

Alternatively or in addition, the controller and/or a database of the vehicle 34 leaving the parking space can be adapted to transmit a data set, which displays the leaving of a previously used parking space, to a central database server, for example by means of a mobile phone connection. The controller ECU of the motor vehicle 10 can be configured conversely in this case to contact the central database server, for example by a mobile phone connection, in the event of a parking wish of a driving instance that has been determined/transmitted, and to interrogate data sets which display recently indicated parking opportunities in the vicinity, for example in a radius of two kilometres of the motor vehicle 10.

Following starting of the vehicle engine of the vehicle 34, the controller of the vehicle 34 shown can automatically transmit a data set, which displays a parking space becoming free, to a central database server and/or to a compatible foreign vehicle interface, for example.

In other variants, a corresponding data set can be transmitted, for example, also as a function of unlocking of the vehicle doors of the vehicle, of an approach of a radio key equipped with a radio transponder to the vehicle 34 or only after a physical departure from the parking space by the vehicle 34. The input of a destination position into a navigation device of the vehicle 34 by a driver and/or the creation of a data connection of a smartphone/mobile associated with the driver of the vehicle 34 to a control system of the vehicle 34 can also trigger the transmission of a data set, which displays the vacating of a parking space.

It is understood that the previously explained exemplary embodiments are not conclusive and do not restrict the subject matter disclosed here. In particular, it is evident to the person skilled in the art that he can combine the features described with one another in any way and/or can omit different features without deviating from the subject matter disclosed here in doing so.

1. A control system for a motor vehicle, based on environmental sensors of the motor vehicle and on a database, wherein
the environmental sensors are arranged and configured to capture an environment of the motor vehicle continuously and to provide environmental data of the motor vehicle;
a position sensor is arranged and configured to detect a position of the motor vehicle continuously and to provide position data of the motor vehicle;
a speed sensor is arranged and configured to detect a speed of the motor vehicle continuously and to provide speed data of the motor vehicle;
a timer is configured to determine respectively current time information;
a database is configured to store transmitted data sets and to provide stored data sets;
an interface is arranged and configured to transmit traffic information to a driving instance of the motor vehicle,
a controller is configured to prepare a data set repeatedly
with the environmental data, and
with the position data, and
with the speed data, and
with time information
and to transmit it to the database, and
to determine traffic information repeatedly using the respectively prepared data set and data sets stored in the database, and
to effect a transmission of the traffic information to the driving instance of the motor vehicle by the interface as a function of the determination.

2. The control system according to claim 1, wherein
the driving instance is a driver of the motor vehicle and the interface is a user interface, or
the driving instance is an autonomous motor vehicle controller and the interface is an electronic data interface for autonomous motor vehicle control.

3. The control system according to claim 1, wherein:
the environmental sensor system comprises a plurality of sensors, and/or
the environmental sensor system comprises at least one optically detecting sensor, in particular a camera sensor, and/or
the environmental sensor system is further configured and arranged to capture an environment of the motor vehicle at least substantially without interruption.

4. The control system according to claim 1, further comprising:
at least one operating element, which is arranged and configured to detect a control action of the driving instance, in particular of the driver of the motor vehicle, and
depending on the detection of the control action, to transmit control information to the controller,
wherein the controller is further configured to prepare the data set additionally with the control information.

5. The control system according to claim 1, further comprising:
at least one display element for the driver of the motor vehicle, which is connected electronically to the user interface and is arranged and configured
to display the traffic information for the driver of the motor vehicle in an optically recognisable manner, and/or
to transmit to the driver of the motor vehicle an optical and/or acoustic and/or haptic warning signal as a function of the traffic information.

6. The control system according to claim 2, wherein:
the interface is further adapted to issue a control command to an actuator controller of the motor vehicle, and/or
to transmit to the driver of the motor vehicle an optical warning signal, in particular with the display element, as a function of the control command, and/or
to transmit to the driver of the motor vehicle an acoustic and/or haptic warning signal as a function of the control command.

7. The control system according to claim 1, further comprising:
an evaluation unit, which is configured in a predetermined evaluation time interval to repeatedly
read stored data sets from the database, and
compare the read data sets, and
depending on the comparison of the read data sets, add evaluation information, for example hazard information, to the data sets, and
store the data sets with the stored evaluation information in the database.

8. Control system according to claim 1, wherein:
the database is implemented outside the motor vehicle, for example with a stationary database server, and/or
the database is adapted to be connected by a wireless data connection, for example by a mobile phone connection or satellite communication connection, at least temporarily to the controller of the motor vehicle,
the database is adapted to store transmitted data sets of a plurality of control systems according to claim 1, and/or
to provide stored data sets of a plurality of control systems according to claim 1.

9. Control system according to claim 1, further comprising:
at least one foreign vehicle interface, which is arranged and configured
to detect another foreign vehicle interface, which is arranged in another motor vehicle, for example in another motor vehicle with a control system according to claim 1, in a predetermined area around the motor vehicle, and
to set up a wireless data connection with the foreign vehicle interface of the other motor vehicle, and
to read from the foreign vehicle interface of the other motor vehicle
environmental data, and/or
position data, and/or
speed data, and/or
time information, and/or
control information, and/or
hazard information
and to transmit it to the controller, and/or
to transmit to the foreign vehicle interface of the other motor vehicle
environmental data, and/or
position data, and/or
speed data, and/or
time information, and/or
control information, and/or
hazard information
wherein
the controller is further configured to determine the traffic information also using data and/or information read from the foreign vehicle interface of the other motor vehicle.

10. A control method for a motor vehicle, based on environmental sensors of the motor vehicle and on a database, comprises the steps:
continuous capture of an environment of the motor vehicle and provision of environmental data of the motor vehicle by the environmental sensors;
continuous determination of a position of the motor vehicle and provision of position data of the motor vehicle by a position sensor;
continuous detection of a speed of the motor vehicle and provision of speed data of the motor vehicle by a speed sensor;
determination of respectively current time information by a timer;
repeated preparation, respectively after the expiry of a predetermined time interval, of a data set with
the environmental data, and
the position data, and
the speed data, and
time information
by a controller;
transmission of the determined data set to a database, which is configured to store transmitted data sets and to provide stored data sets;
repeated determination of traffic information using the respectively prepared data set and data sets stored in the database;
effecting transmission of the determined traffic information to an interface;
transmission of the traffic information to a driving instance of the motor vehicle by the interface as a function of the determination of the traffic information by the controller.
